(19) United States
(12) Patent Application Publication
(10) Pub. No.: US 2019/0227458 A1
(43) Pub. Date: Jul. 25, 2019

(54) IMAGE FORMING APPARATUS

(71) Applicant: CANON KABUSHIKI KAISHA, Tokyo (JP)

(72) Inventor: Masanori Akita, Abiko-shi (JP)

(21) Appl. No.: 16/374,889

(22) Filed: Apr. 4, 2019

Related U.S. Application Data
(63) Continuation of application No. PCT/JP2017/037094, filed on Oct. 5, 2017.

(30) Foreign Application Priority Data
Oct. 5, 2016 (JP) 2016-197043

(51) Int. Cl. G03G 15/08

(52) U.S. Cl. CPC G03G 15/0856; G03G 15/0865

(57) ABSTRACT

A developer carrying member for carrying a developer containing toner and a carrier and for developing an electrostatic image on a photosensitive member, a developer container in which the developer is electrically charged and is carried on the developer carrying member, a detecting portion for detecting a toner content, a video count means for counting and integrating the number of development dots of entirety of an image, and a supplying device for supplying a developer for supply to the developer container depending on a consumption amount of the toner are provided, and first and second toner supply amounts are acquired on the basis of outputs of the video count means and the detecting portion, and in the case where as regards a final toner supply amount determined on the basis of the first and second toner supply amounts, a fluctuation in predetermined during printing is increased from a first value to a second value, a ratio of the second toner supply amount to the first toner supply amount is decreased.

### TECHNICAL FIELD

The present invention relates to an image forming apparatus, such as an electrophotographic copying machine or a laser beam printer, including a developing device for developing an electrostatic image formed on an image bearing member into a toner image.

### BACKGROUND ART

An image forming apparatus in which an electrostatic image written on a photosensitive member is developed into a toner image with a developer (two-component developer) containing toner (non-magnetic) and a carrier (magnetic) has been widely used. In the developing device using the two-component developer, a toner charge amount is maintained at a certain value by adjusting a toner content occupied in the developer so that the electrostatic image formed under a predetermined charging/exposure condition is developed in a predetermined toner application amount.

In control of maintaining the toner charge amount at the certain value, when the toner charge amount decreases, the toner application amount increases and an image density increases even when the same electrostatic image is used, and therefore, the toner charge amount is increased by decreasing a ratio of the toner as toner supply control and by increasing an opportunity of friction of the developer. On the other hand, when the toner charge amount increases, the toner application amount per unit area decreases and an image density lowers even when the same electrostatic image is used, and therefore, the toner charge amount is lowered by increasing a ratio of the toner as toner supply control and by reducing an opportunity of friction of the developer.

As regards the toner supply control, Japanese Laid-Open Patent Application (JP-A) Hei 05-027527 discloses, as video count control, a video count means for counting and integrating the number of binary-modulated development dots, of entirety of an image, supplied to a light source of an exposure device. This means calculates an amount of toner consumed when an image on one sheet is formed through development by processing image data and an exposure signal which are subjected to image formation, and supplies a developer for supply in an amount corresponding to the amount of the consumed toner, whereby a fluctuation in ratio of the toner occupied in the developer is suppressed.

Further, JP-A Hei 01-182750 discloses a detecting portion using, as inductance control, a (magnetic) permeability sensor (inductance sensor) for outputting a signal depending on a toner content (concentration) by using an increase in permeability of the developer (two-component developer) with an increase in ratio of a carrier.

Further, JP-A Hei 06-149057 discloses, as patch image control, an optical sensor for outputting a signal depending on a toner application amount of a patch image by irradiating the patch image formed at an image interval during continuous image formation with LED light and then by detecting a specular reflection light quantity. This supplies a developer for supply to a developer container (developing container) so that the toner application amount of the patch image formed under a predetermined charging/exposure condition converges to a predetermined value, whereby a toner content of the developer (two-component developer) is changed. This control is so-called patch detection ATR (Auto Toner Replenishing).

Further, JP-A 2011-48118 discloses, as triple control, toner supply control for stabilizing an output image density with balance by using the video count control, the inductance control and the patch detection ATR control. In this case, control in which a toner supply amount corresponding to an estimated toner consumption amount is calculated using the video count means in a feed forward manner and in which a deviation of the toner content from a reference value is corrected in a feedback manner by an inductance controller is carried out.

As regards the triple control, when only the inductance control is used in the case where the toner charge amount is large, the toner content lowers beyond expectation in some cases by a delay of detection due to a difference in time until the toner supplied by the inductance control after the toner supply reaches the inductance sensor. Accordingly, it is preferable from the viewpoint of improvement in accuracy of the toner supply that an approximate toner supply amount is determined by video count information and is corrected by inductance information.

Further, it has been well known that even in the same toner content, a carrier charging performance lowers due to toner deposition onto a carrier surface and the toner charge amount gently lowers with endurance. Accordingly, a toner content target value by the inductance control may preferably be changed by the patch detection ATR with a low frequency.

Thus, even in the case of using a large toner charge amount or in the case where the carrier charging performance is changed with endurance, it becomes possible to stabilize an output image density without remarkably lowering productivity.

### SUMMARY OF THE INVENTION

### Problems to be Solved by the Invention

However, even when the control of JP-A 2011-48118 is used, the output image density fluctuated in some cases. Specifically, there is a case that images with a high print ratio (hereinafter referred to as high print ratio images) are continuously printed immediately after images with a low print ratio (hereinafter referred to as low print ratio images) are continuously printed.

That is, in the case where the low print ratio images are continuously printed, triboelectric charge between the toner and the carrier is excessively carried out due to less replacement of the toner in a developing device, so that there is a tendency that the toner charge amount becomes high. Accordingly, in order to suppress this, in the case of the control of JP-A 2011-48118, the target toner content of the inductance controller is set at a high value by the patch detection ATR executed with the low frequency.

In this situation, in the case where continuous printing of the high print ratio images is carried out subsequently, the toner supply with the toner consumption in a large amount is carried out with a high frequency, so that a stirring time is shortened and thus the toner charge amount quickly lowers. As regards this quick lowering in toner charge amount, in the case of the control of JP-A 2011-48118, when the frequency of the patch detection ATR is low, a change in target value of the toner content by the inductance control cannot follow the quick lowering of the toner charge amount and thus the toner charge amount continuously lowers, with the result that image density rise occurs in some instances.

Further, in the case of the control of JP-A 2011-48118, the target toner content of the inductance controller is set at the high value during the continuous printing of the low print ratio images, and therefore, the lowering in toner charge amount during the continuous printing of the high print ratio images is conspicuous by double factors of an insufficient stirring time and high toner content setting. On the other hand, in the case where the patch detection ATR is executed with a high frequency so as to follow the lowering in toner charge amount, a lowering productivity occurs unpreferably.

An object of the present invention is to provide an image forming apparatus capable of suppressing an image density fluctuation which can occur during supplying from a low print ratio image to a high print ratio image without remarkably lowering productivity.

According to an aspect of the present invention, there is provided an image forming apparatus comprising: an image bearing member; a developer carrying member for carrying a developer containing toner and a carrier and for developing an electrostatic image formed on the image bearing member; a developer container for accommodating the developer to be supplied to the developer container; a detecting portion for detecting a toner content in the developer in the developer container; a supplying device for supplying the toner to the developer container; and a controller for controlling an amount of the toner supplied from the supplying device to the developer container on the basis of a first toner supply amount acquired on the basis of an image ratio of an image formed on the image bearing member and a second toner supply amount acquired so that the toner content is a target value on the basis of an output of the detecting portion, wherein in a case that an image ratio of a plurality of continuous image is higher than an image ratio of a predetermined number of continuous images and that a fluctuation of the image ratio of the plurality of continuous images to the image ratio of the predetermined number of continuous images is larger than a predetermined value, the controller controls the second toner supply amount so that the second toner supply amount is less than the second toner supply amount in a case that the fluctuation is smaller than the predetermined value.

According to another aspect of the present invention, there is provided an image forming apparatus comprising: an image bearing member; a developer carrying member for carrying a developer containing toner and a carrier and for developing an electrostatic image formed on the image bearing member; a developer container for accommodating the developer to be supplied to the developer container; a detecting portion for detecting a toner content in the developer in the developer container; a supplying device for supplying the toner to the developer container; and a controller for controlling an amount of the toner supplied from the supplying device to the developer container on the basis of a first toner supply amount acquired on the basis of an image ratio of an image formed on the image bearing member and a second toner supply amount acquired so that the toner content is a target value on the basis of an output of the detecting portion, wherein the controller controls the amount of the toner so that an amount of the toner supplied after continuous image formation of images with a second image ratio of 30% or more is started after continuous image formation of a preset number of images with a first image ratio of 5% or less is less than an amount of the toner supplied after image formation of a preset number of images with the second image ratio of 30% or more.

### Effect of the Invention

According to the present invention, the image density fluctuation which can occur during the switching from the low print ratio image to the high print ratio image can be suppressed without remarkably lowering the productivity.

### BRIEF DESCRIPTION OF THE DRAWINGS

FIG. 1 is an illustration of a structure of an image forming apparatus according to an embodiment of the present invention.

FIG. 2 is an illustration of a structure of an image forming portion for yellow in the image forming apparatus according to the embodiment of the present invention.

FIG. 3 is an illustration of a structure of a developing device in the image forming apparatus according to the embodiment of the present invention.

FIG. 4 is a flowchart of toner supply control in a conventional example.

FIG. 5 is an illustration of a conversion table between a difference in TD ratio and a necessary toner supply amount.

FIG. 6 is an illustration of a conversion table between a video count value and a toner consumption amount.

FIG. 7 is an illustration of a structure of Faraday-cage for measuring a toner charge amount.

FIG. 8 is a flowchart of toner supply control according to the embodiment of the present invention.

### EMBODIMENT FOR CARRYING OUT THE INVENTION

An embodiment of the present invention will be described using the drawings.

### Embodiment 1

### (Image Forming Apparatus)

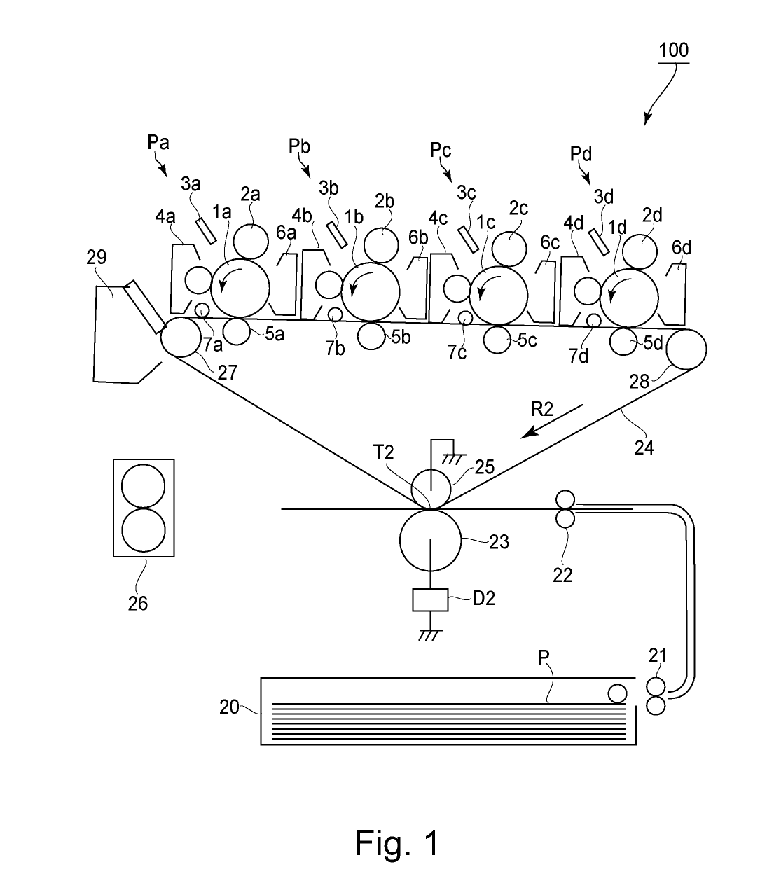

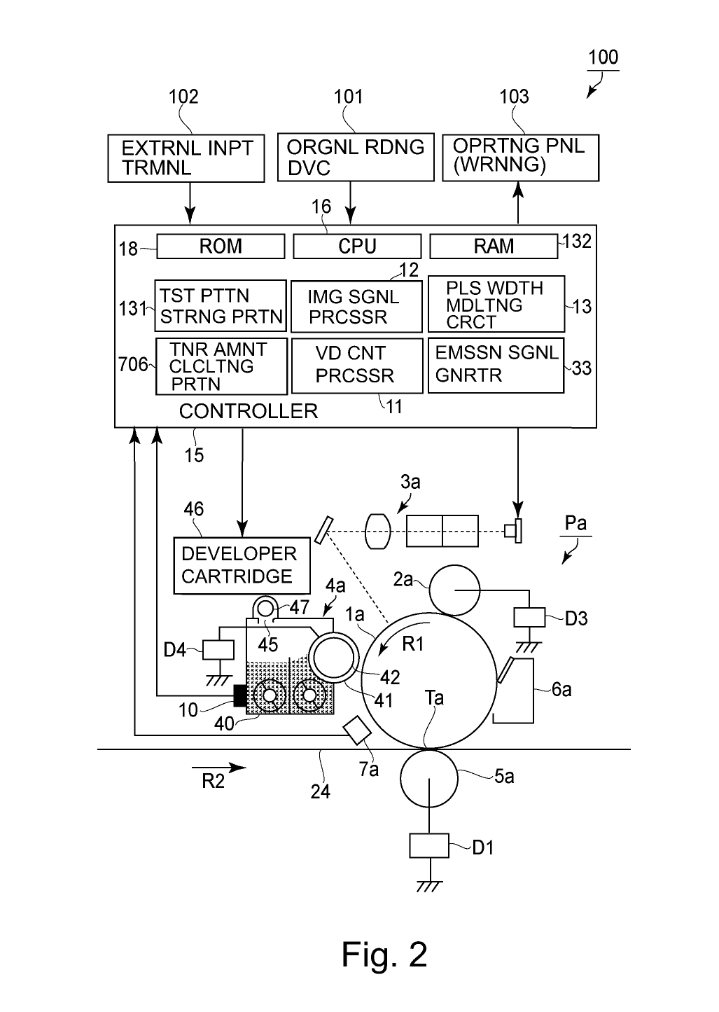

FIG. 1 is an illustration of a structure of an image forming apparatus according to this embodiment. FIG. 2 is an illustration of a structure of an image forming apparatus for yellow. As shown in FIG. 1, an image forming apparatus 100 is a full-color printer of a tandem type and an intermediary transfer type, in which image forming portions Pa, Pb, Pc and Pd for yellow, magenta, cyan and black are arranged along an intermediary transfer belt 24. At the image forming portion Pa, a yellow toner image is formed on a photosensitive drum 1a and is primary-transferred onto the intermediary transfer belt 24.

At the image forming portion Pb, a magenta toner image is formed on the photosensitive drum 1b and is primary-transferred superposedly onto the yellow toner image on the intermediary transfer belt 24. At the image forming portions Pc and Pd, a cyan toner image and a black toner image are formed and successively primary-transferred superposedly onto the intermediary transfer belt 24 in a similar manner.

Four color toner images primary-transferred on the intermediary transfer belt 24 are conveyed to a secondary transfer portion T2 and are secondary-transferred collectively onto a recording material P. The recording material P pulled out of a recording material cassette 20 is separated one by one by a separating roller 21 and then is sent toward a registration roller 22. The registration roller 22 receives the recording material P in a rest state and causes the recording material P to be put on standby, and then sends the recording material P toward the secondary transfer portion T2 so as to be timed to the toner images on the intermediary transfer belt 24. Then, the recording material P on which the four color toner images are secondary-transferred is, after the toner images are fixed on the surface thereof under application of heat and pressure by a fixing device 26, discharged to an outside of the image forming apparatus.

The image forming portions Pa, Pb, Pc and Pd have the substantially same constitution except that colors of toners used in developing devices 4a, 4b, 4c and 4d are different from each other so as to be yellow, magenta, cyan and black. In the following, the image forming portion Pa is described, and as regards the image forming portions Pb, Pc and Pd, description will be made reading a suffix a added to constituent members of the image forming portions, as b, c and d, respectively.

The intermediary transfer belt 24 is extended and supported by a tension roller 27, a driving roller 28 and an opposing roller 25 and is driven by the driving roller 28, so that the intermediary transfer belt 24 is rotated at a process speed of 300 mm/sec in an arrow R2 direction. A secondary transfer roller 23 forms the secondary transfer portion T2 in contact with the intermediary transfer belt 24 supported by the opposing roller 25 at an inside surface of the intermediary transfer belt 24. A DC voltage is applied from a voltage source D2 to the secondary transfer roller 23, whereby the toner image carried on the intermediary transfer belt 24 is secondary-transferred onto the recording material P.

A belt cleaning device 29 causes a cleaning blade to slide on the intermediary transfer belt 24 and collects transfer residual toner which is not transferred onto the recording material P and passes through the secondary transfer portion T2 and which remains on the intermediary transfer belt 24.

As shown in FIG. 2, an original to be copied is read by an original reading device 101. The original reading device 101 includes a photoelectric conversion element for converting an original image from a CCD or the like into an electric signal, and outputs image signals corresponding to yellow image information, magenta image information, cyan image information and black image information, respectively, of the original to be copied.

At the image forming portion Pa, as shown in FIG. 1, at a periphery of the photosensitive drum 1a which is an example of an image bearing member, a charging roller 2a, an exposure device 3a, a developing device 4a, a primary transfer roller 5a and a cleaning device 6a are disposed. The photosensitive drum 1a includes a photosensitive layer with a negative charge polarity formed on an outer peripheral surface of an aluminum cylinder and is rotated in an arrow R1 direction at a process speed of 300 mm/sec.

The charging roller 2a is rotated in contact with the photosensitive drum 1a and electrically charges a surface of the photosensitive drum 1a to a uniformly negative dark-portion potential VD under application of an oscillation voltage in the form of a DC voltage biased with an AC voltage from a voltage source D3. The exposure device 3a writes an electrostatic image for an image on the charged surface of the photosensitive drum 1a by a scanning the photosensitive drum surface through a rotatable mirror with a laser beam which is obtained by subjecting scanning line image data, obtained by developing a separated color image of yellow, to ON-OFF modulation. The developing device 4a causes the toner to deposit on the electrostatic image (exposed portion) of the photosensitive drum 1a by using a two-component developer, so that the toner image is formed by reverse development as described later.

The primary transfer roller 5a forms a primary transfer portion Ta between the photosensitive drum 1a and the intermediary transfer belt 24 by pressing an inside surface of the intermediary transfer belt 24. A DC voltage of a positive polarity is applied from a voltage source D1 to the primary transfer roller 5a, whereby the toner image carried on the photosensitive drum 1a is primary-transferred onto the intermediary transfer belt 24 passing through the primary transfer portion Ta. The cleaning device 6a causes a cleaning blade to slide on the photosensitive drum 1a and collects transfer residual toner which is not transferred onto the intermediary transfer belt 24 and which remains on the photosensitive drum 1a.

### (Developing Device)

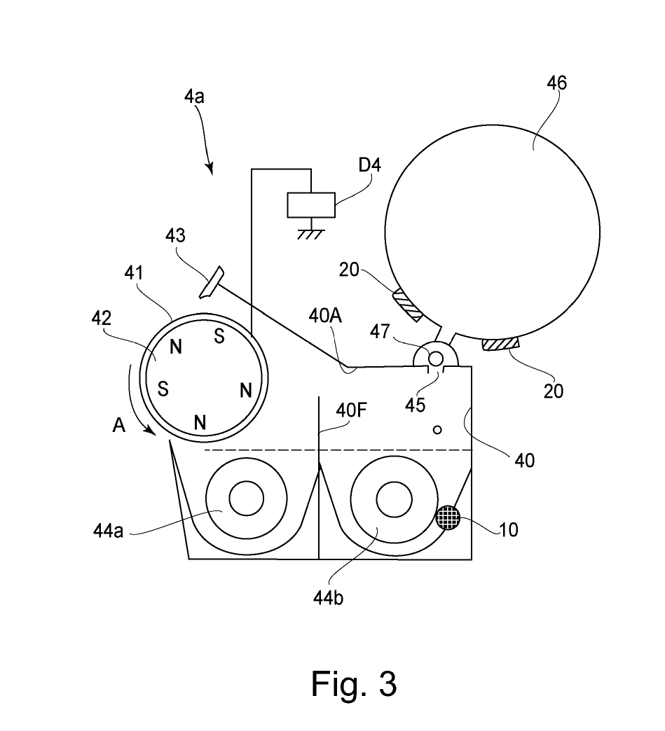

FIG. 3 is an illustration of a structure of the developing device. As shown in FIG. 3, the developing device 4a develops the electrostatic image on the photosensitive member (1a) while carrying the developer on a developing sleeve 41 which is an example of a developer carrying member. A developer container (developing container) 40 stirs and charges the developer by a pair of feeding screw members 44a and 44b and causes the developing sleeve 41 to carry the developer. A developer cartridge 46 which is an example of a supplying device supplies a developer for supply containing the toner to the developer container 40. A toner content sensor 10 which is an example of a toner content detecting portion detects the developer circulating in the developer container 40 and outputs a signal depending on a ratio of the toner occupied in the developer.

In the developer container 40, the developer containing the toner and a carrier as main components is accommodated, and a ratio (toner content, TD ratio) represented by a weight of the toner occupied in the developer in an initial state is 8%. The TD ratio should be properly adjusted depending on a toner charge amount, a carrier particle size, a structure of the developing device 4a or the like, and therefore is not limited to 8%.

The developing device 4a is open in a developing region opposing the photosensitive drum 1a and includes the developing sleeve 41, constituted by a non-magnetic material, provided rotatably so as to be partly exposed through this opening. A magnet 42 as a magnetic field generating means is constituted by a fixed cylindrical magnet having a plurality of magnetic poles with a predetermined pattern along a circumference of the developing sleeve 41. The carrier having a surface on which the toner is adsorbed by triboelectric charge is confined on the developing sleeve 41 by a magnetic field generated by the magnet roller 42.

During a developing operation, the developing sleeve 41 rotates in an arrow A direction (FIG. 3) and holds the developer in the developing container 40 in the form of a layer, and then carries and feeds the developer, so that the developer is fed to a developing region opposing the photosensitive drum 1a. A layer thickness of the developer carried by the developing sleeve 41 is regulated by a regulating member 43 provided in proximity and opposed to the developing sleeve 41.

A voltage source D4 applies an oscillating voltage in the form of a negative DC voltage Vdc biased with an AC voltage to the developing sleeve 41. The developing sleeve 41 to which the negative DC voltage Vdc is applied is negative relative to an electrostatic image (exposure portion) formed on the photosensitive drum (1a), so that the negatively charged toner in the developer is transferred from the developing sleeve 41 onto the photosensitive drum 1a. The developer remaining on the developing sleeve 41 after being used for developing the electrostatic image is collected in the developing container 40 by rotation of the developing sleeve 41 and is mixed with the developer fed by a feeding and stirring screw 44a.

In the developing container 40, feeding and stirring screws 44a and 44b as stirring and feeding members for feeding the developer while stirring the developer are provided in parallel to the developing sleeve 41. The developing sleeve 41 and the feeding and stirring screws 44a and 44b are connected with each other on an outside of the developer container 40 by an unshown common driving motor.

A space in the developing container 40 is partitioned into two spaces by a partition wall 40F. The feeding and stirring screw 44a is disposed in the space on the developing sleeve 41 side, and the feeding and stirring screw 44b is disposed in the space on the developer cartridge 46 side. At longitudinal end portions of the partition wall 40F, unshown openings are formed for circulating the developer in the developer container 40 by delivering the developer between the two spaces.

The feeding and stirring screw 44a supplies the developer to the developing sleeve 41 while feeding the developer from the rear side toward the front side on the drawing sheet. The feeding and stirring screw 44b mixes a developer for supply, supplied from the developer cartridge 46, with the circulating developer while reversely feeding the developer from the front side toward the rear side on the drawing sheet. Thus, the feeding and stirring screws 44a and 44b not only circulate the developer in the developer container 40 but also stir and triboelectrically charge the toner and the carrier.

### (Two-Component Developer)

The toner of the two-component developer in this embodiment contains colored resin particles containing of a binder resin, a coloring agent, and other additives as desired, and contains colored particles to which external additives such as fine powder of colloidal silica are externally added. Further, the toner is a negatively chargeable polyester-based resin material manufactured by a pulverizing method, and may preferably have a volume-average particle size of not less than 4 μm and not more than 8 μm. In this embodiment, the volume-average particle size was 5.5 μm.

The volume-average particle size was measured with the use of a Coulter Counter TA-II (manufactured by Beckman Coulter Inc.). Further, an interface (mfd. by Nikkaki-Bios K.K.) for outputting the number and volume average distributions of the developer from a measured result and a personal computer (“CX-I”, manufactured by Canon K.K.) were used.

As an electrolytic aqueous solution for a measuring sample, 1% NaCl aqueous solution prepared by using a first class grade sodium chloride was used. 0.1 ml of a surfactant, preferably alkyl-benzene sulfonate, was added as a dispersant into 100-150 ml of above-mentioned electrolytic aqueous solution. Then, 0.5-50 mg of the measuring sample was added to the above mixture. Then, the electrolytic aqueous solution in which the sample was suspended was subjected to dispersion by an ultrasonic dispersing device for about 1-3 minutes and was set in the Coulter Counter TA-II.

In the Coulter Counter TA-II, a particle size distribution of the particles of 2-40 μm was measured and the volume-average particle size was obtained with the use of a 100 μm aperture as an aperture. The volume-average particle size was obtained from the thus obtained volume-average distribution.

As the carrier, magnetic particles of surface-oxidized or surface-unoxidized metals, such as iron, nickel, cobalt, manganese, chromium or rare-earth metal, or alloys of these metals or oxide ferrites or the like are usable. A manufacturing method of the magnetic particles is not particularly limited. The carrier is 20-50 preferably 30-40 in volume-average particle size, and is 1×10⁷ Ωcm or more, preferably 1×10⁸ Ωcm or more, in resistivity. In this embodiment, the carrier is φ40 μm in volume-average particle size and 5×10⁸ Ωcm in resistivity.

The volume-average particle size of the carrier was measured with the use of a particle size distribution measuring device (“HEROS”, manufactured by JEOL Ltd.) of the laser diffraction type, in which the range of the particle size of 0.5-350 μm on a volume basis was logarithmically divided into 32 decades, and the number of particles in each channel was measured, and from the results of the measurement, the median diameter of 50% in volume was used as the volume-average particle size.

The resistivity of the carrier was measured using a cell of the sandwich type, which was 4 cm in the area (size) of each of its measurement electrodes, and was 0.4 cm in the gap between the electrodes. The resistivity of the carrier was measured from an electric current which flowed through a circuit under application of 1 kg of a weight and application of an applied voltage E (V/cm) between the both electrodes.

Further, as a carrier with low specific gravity, a resin carrier manufactured through a polymerization method after a magnetic metal oxide and a non-magnetic metal oxide are mixed with a phenolic binder resin in a predetermined ratio can be used. Such a resin carrier is 35 μm in volume-average particle size, 3.6-3.7 (g/cm³) in true density and 53 (A·m²/kg) in magnetization amount.

As regards, the magnetization amount (A·m²/kg) of the magnetic carrier, the magnetic properties were measured with the use of an automatic magnetic property recorder of a vibratory magnetic field type manufactured by Riken Denshi Co., Ltd. Magnetic properties was obtained by measuring a strength of the magnetization of the carrier, packed in a cylindrical shape, in an external magnetic field of 79.6 kA/m (1000 oersted).

The two-component development type has advantages, such as image quality stability and durability of the apparatus, compared with other development types. On the other hand, the toner is consumed, whereby a mixing ratio (the toner content: TD ratio) between the non-magnetic toner and the carrier in the developer container changes, as a developing characteristic is changed by a change in toner charge amount, so that there is a problem that an image density of an output image changes in some instances. For that reason, in order to maintain the image density of the output image at a certain level, the control technique of toner supply in which the TD ratio of the developer or the image density is accurately detected and the toner is supplied with no excess and no deficiency.

### (Toner Supply Control)

The two-component development type has advantages, such as image quality stability and durability of the apparatus, compared with other development types. On the other hand, the toner is consumed, whereby a mixing ratio (the toner content, hereinafter also called a TD ratio) between the non-magnetic toner and the carrier in the developer container changes, as a developing characteristic is changed by a change in toner charge amount, so that there is a problem that an image density of an output image changes in some instances. For that reason, in order to maintain the image density of the output image at a certain level, the above-described control technique of toner supply in which the TD ratio of the developer or the image density is accurately detected and the toner is supplied with no excess and no deficiency.

### 1) Video Count Control

A video count detecting portion (video count calculating means) which is an image ratio calculating portion for calculating the image ratio counts a video count number of a density signal of an image information signal for each pixel, so that the developer for supply in an amount corresponding to a toner consumption amount estimated on the basis of the video count number is supplied. However, only by video count control, a supply fluctuation of consumed toner and supply performance non-uniformity of the supplying device for the developer for supply occur, and therefore, there is no problem as to supply in a short period, but there is a disadvantage such that the TD ratio is deviated gradually due to a fluctuation in long-term fluctuation or accumulation of the non-uniformity.

### 2) Inductance Control

By detecting a change in lowering apparent permeability of the developer (inductance detection), the TD ratio as the mixing ratio (toner content) between the non-magnetic toner and the carrier is discriminated, so that the developer for supply is supplied.

### 3) Patch Image Control

A patch image is formed during non-image formation of image formation, and the image density is detected measured by image density detecting sensor. Then densities of an initial patch image acquired in advance and the prepared patch image are compared with each other, and when a density lowering is detected, the developer for supply is supplied, and when a density rise is detected, the supply is stopped. This operation is repeated.

### 4) Triple Control

In this embodiment, the output image density is stabilized with good balance by employing the triple control type by (video count)+(inductance)+(patch detection ATR control). That is, while the toner consumption amount is estimated and the toner supply in an amount corresponding to the toner consumption is carried out in a feed forward manner, supply amount non-uniformity is corrected in a feedback manner by correcting a deviation of the toner content with respect to a reference value of the toner content by the inductance control.

Only by the inductance control, for example, in the case where the toner charge amount is large, the toner content lowers more than expected in some instances due to a delay of detection by a difference in time until the toner supplied by the inductance control after the toner supply reaches a detecting position. Accordingly, it is preferable from the viewpoint of an improvement in accuracy of the toner supply that an approximate toner consumption amount is determined by video count information and is corrected by inductance information.

Further, depending on a patch image density acquired by the patch detection ATR control, a target value of the toner content in the inductance control is appropriately changed. This is because it is well known that even at the same toner content, the carrier charging performance lowers due to toner deposition on the carrier surface and the toner charge amount moderately lowers with endurance, and this problem is required to be addressed.

(Basic Principle and Function of Toner Supply in this Embodiment)

It is a premise that an apparatus (device) for calculating the toner supply amount corresponding to the estimated toner consumption amount in the feed forward manner by using the video count and for correcting the deviation of the toner content with respect to the reference value in the feedback manner is used. Then, when low print ratio images are continuously printed, a degree of replacement of the toner in the developing device is small, and therefore, the toner is excessively stirred and the toner charge amount increases. In order to suppress this increase in toner charge amount, the friction occurrence of the developer is reduced by increasing the toner content, so that the toner charge amount is lowered.

Here, in the case where high print ratio images with (high) image ratio are printed immediately after the low print ratio images are printed, the toner charge amount abruptly lowers in respects of a toner content in a state in which the toner content is set for the low print ratio image at a high level and of print of the high print ratio images in which the toner is supplied in a large amount.

On the other hand, the ATR patch control cannot lower a target toner content because the control is carried out at a low frequency, and therefore, the print is carried out while the toner charge amount is kept in a small state so that the image density fluctuates toward a dense (high) direction (a color (hue) fluctuation occurs).

Therefore, in this embodiment, in the case where the high print ratio images are printed immediately after the low print ratio images are printed, the toner is continuously supplied when the control follows the inductance control and thus the toner charge amount lowers, and therefore, an inductance supply coefficient is made small. That is, only the toner supply control using the video count is substantially carried out.

(Flowchart of this Embodiment Against Conventional Example)

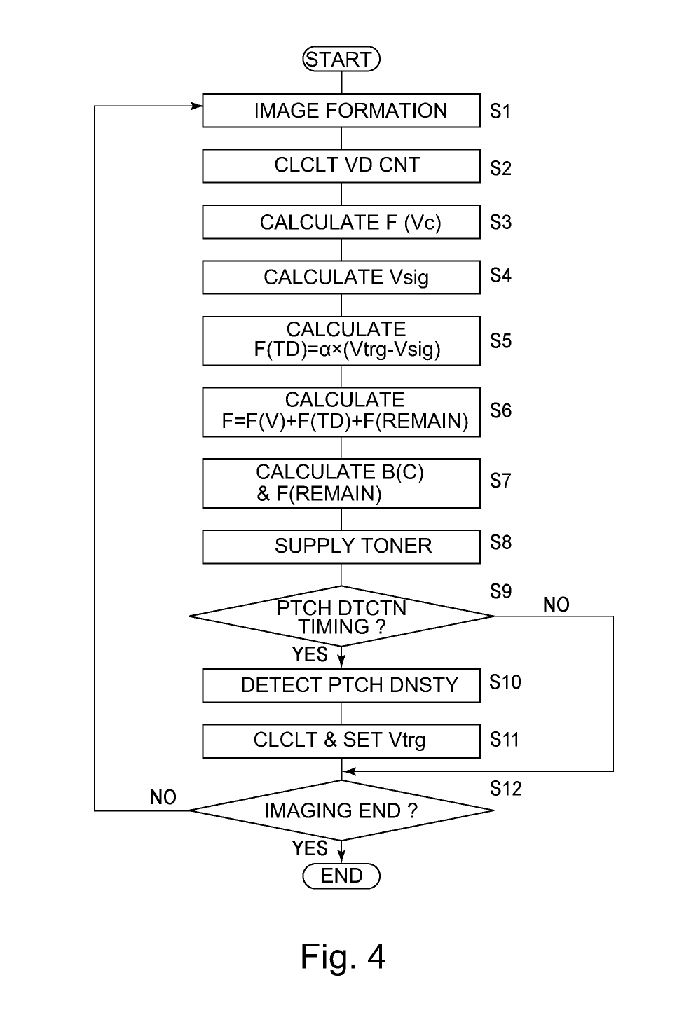

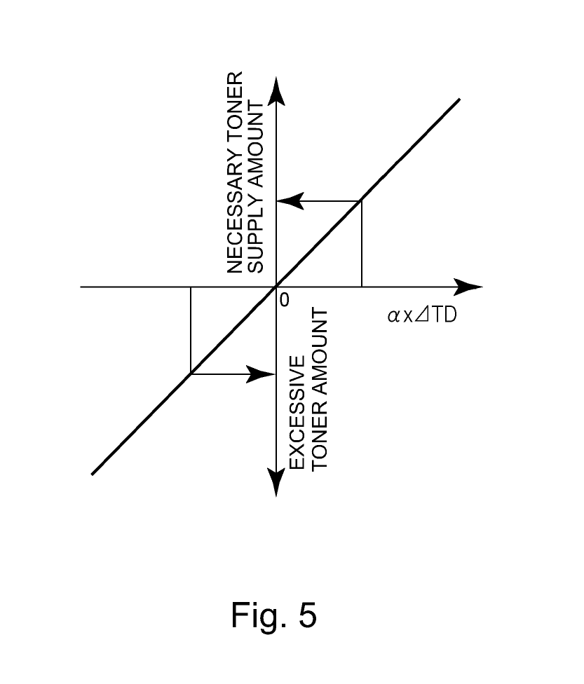

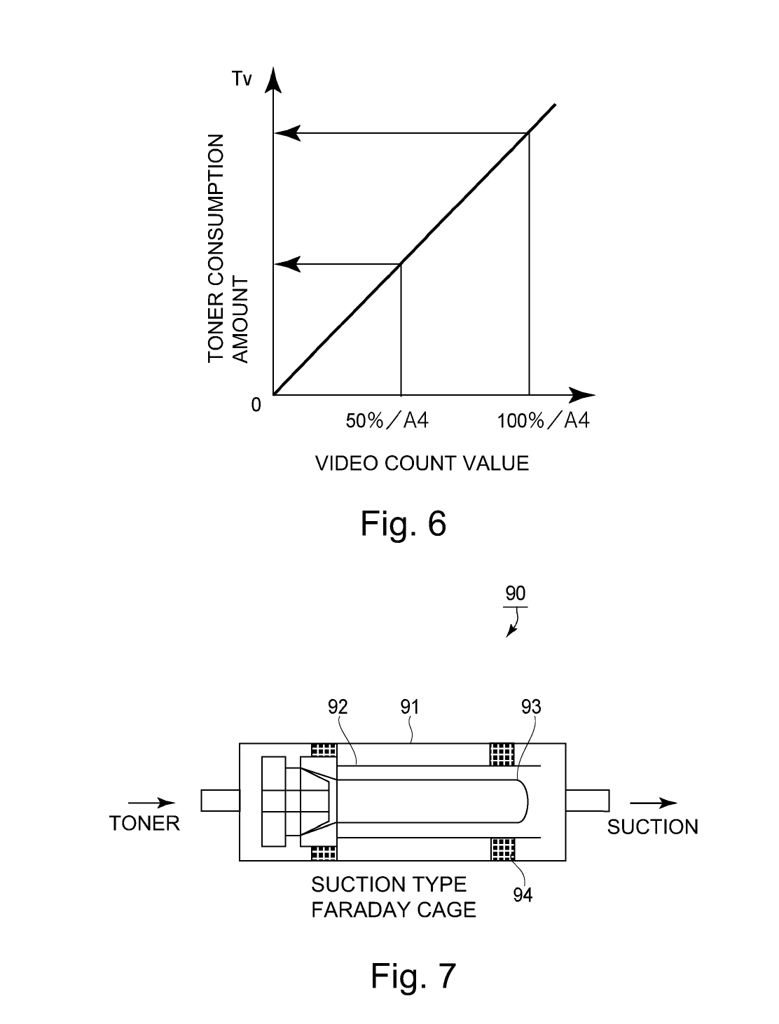

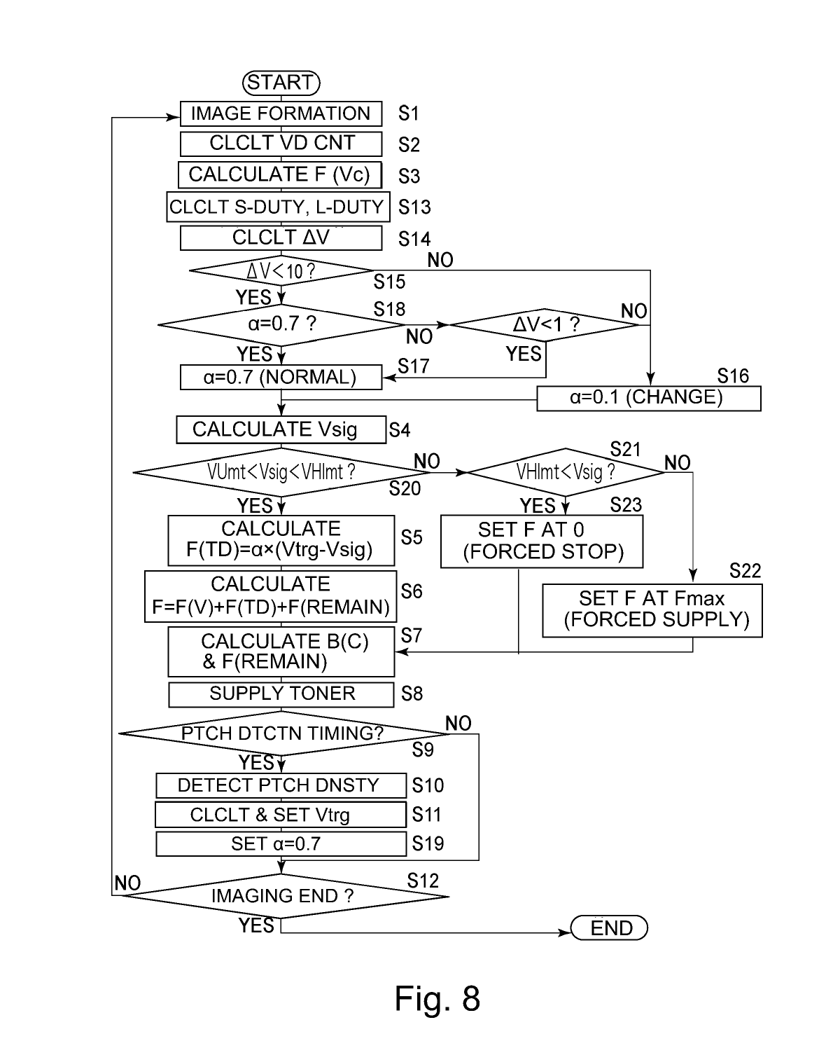

FIG. 4 is a flowchart of conventional control, and FIG. 8 is a flowchart of control of this embodiment improved on the basis of the flowchart of the conventional control. FIG. 5 is an illustration of a conversion table between a difference of the TD ratio and a necessary toner supply amount with respect to the inductance control. FIG. 6 is an illustration of a conversion table between the video count value and the toner consumption amount with respect to the video count control.

In the image forming apparatus 100 of this embodiment shown in FIG. 1, supply control of a triple control type by the video count control, the inductance control and the patch image control is employed as to the toner supply amount. Further, in order not to remarkably lower productivity, a formation frequency of the patch image is lowered by making an execution interval of the patch image control long. Further, in this embodiment, a target value of the TD ratio in the developing device 4a is changed depending on the patch image density detected in the patch image control (patch detection ATR control).

By this, a supply amount F (TD) of the developer for supply is calculated (acquired) so that the TD ratio measured using the toner content sensor 10 is the changed target value of the TD ratio. Then, an amount corresponding to the toner consumption amount estimated (acquired) from the video count value is added to the calculated supply amount, so that an actual supply amount (final toner supply amount) is calculated.

Now, as shown in FIG. 3, the developer cartridge 46 as the supply device of the developer for supply has a substantially cylindrical shape for each of all of yellow, magenta, cyan and black, and is detachably mountable easily to the image forming apparatus 100 through a mounting portion 20.

In FIG. 3, an upper wall 40A of the developer container 40 in the neighborhood of the feeding and stirring screw 44b of the developing device 4a is provided with a developer supplying opening 45. At the developer supplying opening 45, a developer supplying screw 47 for feeding the developer for supply is provided. In the developing device 4a, the developer for supply in an amount corresponding to the amount of the toner consumed by the image formation is supplied from the developer cartridge 46 into the developer container 40 through the developer supplying opening 45 by a rotational force of the developer supplying screw 47 and gravitation. Incidentally, as a supplying method, a well-known block supplying type (method) is employed.

The block supplying type refers to control such that an arbitrary toner supply amount is not supplied at any time, but the toner for supply is stored until the toner supply amount reaches a preset one block toner supply amount (200 mg in this embodiment), the toner is supplied by rotation of the supplying screw 32 through one full circumference for each (one) block supply amount of 200 mg. The toner supply amount increases or decreases depending on a screw phase of the supplying screw, and therefore, in order to obtain a stable supply amount, the block supplying type in which the toner is supplied always every one cyclic period may preferably be employed. In this embodiment, two block supply for A4 size and four block supply for A3 size are set at a maximum supply number in which the toner is supplied per (one) sheet.

In this embodiment, the toner supply control (toner replenishing control) of the controller 15 (FIG. 2) for the developer cartridge 46 as the supplying device of the developer for supply uses a type in which the following three toner supply amount controllers are used in combination. Thus, by combining first, second and third controllers with each other, in this embodiment, it becomes possible to stabilize the output image density.
1) First controller (portion): consumption amount supply control (video count control) in which the toner supply amount is set so as to correspond to the toner consumption amount for each image detected using a video count processing circuit 11 (FIG. 2)

In this controller, video count detection supply control in which an exposure sensor (or a density sensor of an image information sensor) of the image during the image formation is processed by the video count processing circuit 11 and the toner supply amount for each image is acquired is carried out.
2) Second controller: toner content control (inductance control) in which the toner supply amount is set so as to maintain the TD ratio, at a certain value, detected using the toner content sensor 10 (FIG. 2)

As the toner content sensor 10, an inductance detecting sensor for detecting an apparent permeability change in the developer lowered by an increase in TD ratio and for calculating the TD ratio was employed. The toner content sensor 10 lowers in output with a relative decrease in carrier by an increase in TD ratio and increases with a relative increase in carrier by a lowering in TD ratio.

In this controller, in the developer container 40 is detected by the toner content sensor 10, and this density sensor is compared with an initial reference signal stored in advance, and TD ratio detection supply control is carried out on the basis of a comparison result.
3) Third controller: toner charge amount control (patch image control) in which the toner supply amount is set so that the patch image detected using an image density sensor 7a (FIG. 2) is maintained at a certain value

The image density sensor 7a detects the patch image formed on the photosensitive drum 1a under a predetermined image forming condition and outputs an image depending on the toner application amount. The image density sensor 7a disposed opposed to the photosensitive drum 1a and is an optical sensor of a regular (specular) reflection type in which LED light is emitted and regularly reflected light from the surface of the photosensitive drum 1a is detected. When an amount of toner particles on the surface of the photosensitive drum 1a increases, scattering reflected light increases and regularly reflected light decreases, and therefore an output sensor depending on the toner application amount of the patch image is obtained.

As regards the controller, a half-tone patch image is formed on the photosensitive drum 1a under a predetermined image forming condition, and thereafter a density sensor corresponding to the toner application amount of the patch image is detected by the image density sensor 7a. Then, the density sensor and the initial reference sensor stored in advance are compared with each other, and the patch detection supply control is carried out on the basis of a comparison result thereof.

This patch detection supply control is carried out for periodically correcting an initial reference sensor (Vtrg of FIG. 8) used in the TD ratio detection supply control (controller) which is the second controller. This control as described above predicts a developing characteristic by detecting the image density sensor 7a of the patch image formed on the photosensitive drum 1a and changes a target TD ratio (initial reference sensor Vtrg of FIG. 8) of the developer in the developing device 4a.

Then, after setting of such a target ratio, the supplying device (46) is controlled on the basis of an output Vsig of the detecting portion (toner content sensor 10) in the second controller so that the ratio of the toner occupied in the developer converges to the target TD ratio Vtrg as a target ratio.

### (Flowchart of Conventional Example)

Before a flowchart in this embodiment, a flowchart of a conventional example which is a premise of the flowchart in this embodiment will be described. In FIG. 4, when image formation is started (S1), the video count processing circuit 11 (FIG. 2) calculates a video count value during the image formation (S1). The video count value is a count number obtained by counting H-level, for each pixel, of an output signal obtained by subjecting an output of the image signal processing circuit 12 (FIG. 2) to pulse width modulation by the pulse width modulating circuit 13 (FIG. 2).

This count value is integrated over an entirety of an original paper size, so that a video count number N corresponding to a development dot number per one original sheet of entirety of the image is calculated. Further, the print ratio is acquired from the video count number, and in this conventional example, the video count number N=512 of a whole surface solid image (image of 100% in print ratio) on one surface of an A4-size sheet for a certain one color is set. For example, the print ratio in the case of video count=26 is acquired as 5% through ratio calculation.

Thereafter, the toner consumption amount, i.e., a necessary toner supply amount F(V) (hereinafter, this amount is referred to as a “control supply amount by video count”) by making reference to the conversion table of FIG. 6 with the calculated video count number N (S2). The conversion table of FIG. 6 is a video count-supply amount conversion table, in which the abscissa represents the video count number N per one sheet of the original, and the ordinate represents the necessary toner supply amount F(V).

Here, a density sensor Vsig of the TD ratio of the developer is detected using the toner content sensor 10 (FIG. 2) provided in the developing device 4a (S4). Next, the target TD ratio Vtrg which has already been acquired and stored in the memory and the density signal Vsig are compared with each other, so that a difference (ΔTD) is acquired (S5).

When description is made further specifically, in the case of ΔTD=Vtrg−Vsig>0, discrimination that an actual TD ratio is lower than the target TD ratio is made, and a toner supply amount F (TD) (hereinafter referred to as a toner content control supply amount) is calculated by making reference to a conversion table of FIG. 5 with ΔTD. On the other hand, in the case of ΔTD=Vtrg−Vsig≤0, discrimination that the actual TD ratio is higher than the target TD ratio is made, and the toner supply amount F(TD) shown below is calculated by making reference to the conversion table of FIG. 5 with ΔTD.

In the conversion table of FIG. 5, the abscissa represents a value obtained by multiplying the difference ΔTD of an actual signal value by an adjusting coefficient (correction coefficient) a of TD relative sensitivity or the like, and the ordinate represents a necessary toner supply amount with respect to a positive direction and an excessive toner amount with respect to a negative direction. Accordingly, in the case of ΔTD<0, the supply toner amount F(TD) is calculated as a negative (−) value.

F(TD)=α×ΔTD=α×(Vtrg−Vsig)

How in FIG. 4, an actual toner supply amount F to be actually supplied is determined by the following formula (S6). Incidentally, “F(REMAIN)” is the remainder of the last supply control and will be described later.

F=F(TD)+F(V)+F(REMAIN)

Then, a necessary block supply number B(C) is acquired by dividing the above-described supply amount F by one block supply amount (S7).

B(C)=F/one block supply amount (200 mg)
Integer Part: Supply
The remainder: F(REMAIN).
   When B(C)>1 is satisfied, the supply control is carried out corresponding to the block supply number corresponding to the integer (S8). The amount corresponding to the supply amount which is less than the one block supply amount is carried over, as F(REMAIN), to subsequent supply timing.

Here, the patch detection supply control is carried out by forming the patch image in an image interval (during non-image formation) on the photosensitive drum 1a with a sheet interval of a predetermined number of sheets during continuous image formation, and the target TD ratio Vtrg of the TD ratio detection supply control is changed depending on a measurement result of the patch image. Specifically, in the case of corresponding to timing determined every 200 sheets subjected to image formation by A4 long edge feeding (YES of S9), the patch detection supply control is carried out. However, in the case where the timing is not that timing, the image formation is continued (S9→S1).

In the patch detection supply control, an electrostatic latent image for a reference toner image (patch image) having a certain area is formed on the photosensitive drum 1a and is developed by a predetermined developing contrast voltage. Then, the patch image is detected by the image density sensor 7a, so that the density signal SigD is acquired (S10). Then, the acquired density sensor SigD and an initial reference signal SigDref stored in advance in the memory are compared with each other, so that the target TD ratio Vtrg is calculated and set (S11). This will be specifically described below.

That is, in the case of ΔOD=SigD−SigDref≥0, discrimination that the image density of the patch image is low is made, and therefore, there is a need to increase the image density by modifying the target TD ratio in an increasing direction. Accordingly, the target TD ratio necessary to return the image density to the initial density is calculated by the following formula. In the following formula, correction is made by multiplying the actual signal value (SigD−SigDref) by a TD ratio sensitivity adjusting coefficient β

Vtrg=Vtrg+β*ΔOD

On the other hand, in the case of ΔOD=SigD−SigDref<0, discrimination that the image density of the patch image is high is made, and therefore, there is a need to lower the image density by modifying the target TD ratio in a decreasing direction. The target TD ratio (Vtrg) necessary to return the image density from the difference ΔOD to the initial density is calculated by the following formula.

Vtrg=Vtrg+β*ΔOD

After the execution of the above-described patch detection ATR, in the case where the print is continued, the sequence returns to Si, and the image formation is continued (S12).

Now, in the conventional example, by carrying out the supply control of the above-described triple control type, the image density of the output image can be stabilized with a good balance. However, in the case where the high print ratio images are continuously printed (formed) immediately after the low print ratio images are continuously printed, even when the above-described triple control is carried out, the image density fluctuates to not less than an allowable level in some instances.

In the case where the low print ratio images are continuously printed, the number of times of replacement of the toner in the developing device is small, and therefore, the toner and the carrier are excessively triboelectrically charged, so that there is a tendency that the toner charge amount increases. Accordingly, the target TD ratio Vtrg of the inductance controller is set at a high value by the patch detection ATR executed at a low frequency. In this situation, in the case where continuous printing of the high print ratio image is carried out, the toner supply with the toner consumption in a large amount is executed at a high frequency, and therefore, contrary to the above, a stirring time becomes short, so that the toner charge amount abruptly lowers.

In the case where the execution frequency of the patch detection ATR control is low with respect to the lowing speed of the toner charge amount, the change in target TD ratio Vtrg by the inductance control cannot follow the low execution frequency, so that the toner charge amount continuously lowers, with the result that the increase in image density occurs in some instances. Further, a state in which the setting of the toner content is changed to setting of a high toner content during continuous printing of the low print ratio image is formed, and therefore, the lowering in toner charge amount during continuous printing of the high print ratio image becomes severe by a double factor including an insufficient stirring time and the setting of the high toner content.

(Flowchart of this Embodiment)

In this embodiment, in the case where the print image is switched from the low print ratio image (5% or less in this embodiment) to the high print ratio image (30% or more in this embodiment), the image density fluctuation is suppressed by adding control described below to the above-described triple control. In the following, a flowchart of this embodiment will be specifically described. Incidentally, S1-S12 in this embodiment are carried out similarly as in S1-S12 in FIG. 4 (conventional example), and detailed description will be omitted.

### 1) Calculation (Acquisition) of Print Ratio

In this embodiment, the print ratio is calculated from the video count value every image formation of one sheet, and means for storing print ratios for 1000 sheets subjected to the last printing is provided and stores respective video count values as V1 (first-sheet pre-print ratio), V2 (second-sheet pre-print ratio) . . . V1000 (1000-th-sheet pre-print ratio), respectively. Then, the last print ratios V1 to V10 for each image formation are averaged, so that an average print ratio for 10 sheets subjected to the printing (hereinafter, referred to as an “S-DUTY”) is calculated. Further, similarly, the last print ratios V1 to V1000 stored for each image formation are averaged, so that an average print ratio for 1000 sheets subjected to the printing (hereinafter, referred to as an “L-DUTY”) is calculated (S13).

### 2) Calculation (Acquisition) of Print Ratio Change Rate (Fluctuation in Print Ratio)

Then, in this embodiment, as a fluctuation in print ratio, a print ratio change rate ΔV represented by the following equation is acquired by calculation from the S-DUTY and the L-DUTY calculated for each image formation (S14).

ΔV=S-DUTY/L-DUTY

By this, in this embodiment, in the case where the printing is switched from the continuous printing of the low print ratio images to the printing of the high print ratio images, the print ratio change rate ΔV is calculated (acquired) as a high value.

### 3) Change Control of Correction Coefficient α

In this embodiment, control in which the print ratio change rate (fluctuation amount) ΔV is measured every image formation and the adjusting coefficient (correction coefficient) a of the TD ratio sensitivity or the like according to the inductance control in the above-described triple control type is changed on the basis of the print ratio change rate ΔV was used.

That is, in the case where the print ratio change rate ΔV is a predetermined value or more (not less than a threshold of 10) when compared with a change rate threshold (threshold) of 10 set in advance (S15), discrimination that the image print ratio was switched from a low print ratio to a high print ratio is made, so that correction coefficient α=0.1 is set (S16). In the case where the print ratio change rate ΔV is less than the threshold of 10, correction coefficient α=0.7 is set (S17).

Now, as described above, the correction coefficient a is a coefficient by which the difference ΔTD of the density signal Vsig relative to the target TD ratio Vtrg is multiplied. Accordingly, when α is made large, a supply amount becomes large relative to a deviation from the target value. Here, in the case where α is made excessively large, there is a tendency that a ripple of an actual TD ratio becomes large about the target TD ratio Vtrg and is not preferred. This ripple is not detected as toner content rise until the supply toner is fed to a toner content sensor position, and generates by that the toner content reaches a toner content not less than the target toner content by further toner supply in that period, and there is a tendency that a ratio thereof increases when α is made large.

On the other hand, when the correction coefficient a is made small, the toner supply amount F(TD) becomes small, and therefore, in the toner supply amount F=F(TD)+F(V) which is added up, a ratio of F(V) calculated from the video count increases relatively. The toner consumption amount (toner supply amount) calculated from the video count is an estimated (predicted) amount, and therefore, when α is made excessively small, a deviation from a desired toner content is liable to occur by an increase of an influence of an error from the estimated amount and therefore is not preferred.

Accordingly, in this embodiment, in view of the above, in the case of print ratio change rate ΔV=10, α=0.7 is set. Further, in the case of print ratio change rate ΔV≥10, i.e., in the case where there is a large tendency that the printing print ratio is switched from the low print ratio to the high print ratio, α=0.1 smaller than α=0.7 is set.

Now, as described above, during continuous printing of the low print ratio images, the replacement of the toner in the developing device is small in number of times thereof, and therefore, there is tendency that triboelectric charge of the toner and the carrier is excessively performed and the toner charge amount becomes high. Further, corresponding to an increase in toner charge amount, a density of the patch image is detected as a low value during execution of the patch detection ATR control and is controlled in a direction of increasing the target TD ratio Vtrg. In this situation, if the content printing of the high print ratio images is carried out while maintaining the coefficient α=0.7, the following phenomena occur.

1) Correspondingly to consumption of the toner in a large amount, the toner supply amount F(V) by the video count control increases.

2) The toner charge amount of the developer somewhat lowers.

3) Corresponding to the toner charge amount, the image density of a subsequent low print ratio image slightly increases.

4) In addition to 1), the density signal Vsig corresponding to the increase in image density lowers. There is a premise that the target TD ratio Vtrg remains unchanged at Vtrg set during the low print ratio continuous printing until the patch detection ATR control is carried out, and therefore, the supply amount F(TD)=α×ΔTD=α×(Vtrg−Vsig) by the inductance control increases.

5) The toner consumption amount further increases by 1)+4).

Thus, when the high print ratio images are continuously printed, in accordance with the above-described mechanism of 1) to 5), the increase in toner consumption amount and the decrease in toner charge amount are repeated in a snowball manner, so that the image density increases to an out-of-allowable level. On the other hand, in this embodiment, a state in which the printing is switched from the printing of the low print ratio images to the printing of the high print ratio images is discriminated by the print ratio change ΔV, and the correction coefficient is changed to a small value of 6a&=0.1, so that unnecessary toner supply in the above-described 4) can be suppressed to 0.1/0.7, i.e., 1/7.

Further, in this embodiment, α is set at the small value of 0.1, and thus the toner is supplied in an amount smaller than the supply amount acquired from the difference Δ between Vtrg and Vsig, and correspondingly, the toner content in the developing device naturally lowers, with the result that an effect of suppressing the lowering in toner charge amount is also obtained.

Here, as described above, in the first place, when α is made excessively small, there is an influence of an error of a video count supply amount and it is not preferable that α is permanently left at 0.1, and therefore, α is controlled so as to be returned to 0.7 which is a normal value in a period other than the time of switching from the low print ratio (image) to the high print ratio image. In this embodiment, after ΔV≥10 is detected one, control such that a is returned to α=0.7 at the time of detection of ΔV<1, i.e., the time of detection of a start of returning of an average print ratio from the high print ratio to the low print ratio (S18) or the time of execution of the patch detection ATR is carried out (S19).

That is, a maximum number of sheets in which α=0.1 is set after ΔV≥10 is detected falls within a patch detection ATR interval of 200 sheets, and therefore, even when the above-described influence of the error of the video count amount is accumulated, the maximum number of sheets is set so as to go out of the allowable level as the toner content. Incidentally, when α is returned from α=0.1 to α=0.7, control such that Vtrg is once set again at the value of Vsig is carried out. The reason therefor is that the toner content control supply amount F(TD) is limited in a period of α=0.1 and therefore Vsig is deviated from the target TD ratio Vtrg, and abrupt toner supply occurs when α is returned to α=0.7 and thus there is a possibility that an image density fluctuation is caused to occur.

Here, in the case where the deviation between the video count amount and an actual consumption amount becomes further large for some reasons, in order to prevent that the density signal Vsig reaches the out-of-allowable level, for example, an upper limit and a lower limit may also be provided to the toner content. That is, whether or not the density signal Vsig falls within “a lower limit TD ratio (VLlmt) and an upper limit TD ratio (VHlmt) which are allowable as a system” which are recorded in the memory in advance is discriminated (S20). In the case of YES, the sequence goes to a flow of calculating the toner supply amount F as described above in S5.

On the other hand, in the case where the density signal Vsig is discriminated as being below the “lower limit TD ratio (ULlmt) which is allowable as a system” which is recorded in the memory in advance (NO of S21), F=maximum supply amount (forced supply) is carried out forcedly irrespective of F(V) and F(TD) (S22). Here, the lower limit TD ratio (VLlmt) is calculated from a limit of an image defect (a white dropout image due to carrier deposition in this embodiment) occurring during the low TD ratio, and specifically, the initial TD ratio was set at 9%, whereas the lower limit TD ratio was set at 4%.

Further, similarly, in the case where the density signal Vsig is discriminated as being below the “lower limit TD ratio (UHlmt) which is allowable as a system” which is recorded in the memory in advance (YES of S21), F=0 (supply stop) is set forcedly irrespective of F(V) and F(TD) (S23). Here, the upper limit TD ratio (VHlmt) is calculated from a limit of an image defect (a so-called fog such that the latent image is developed with the toner at a white background portion in this embodiment) occurring during the high TD ratio, and specifically, the initial TD ratio was set at 9%, whereas the lower limit TD ratio was set at 12%.

### (Evaluation Result)

The image density fluctuation when 30%-print ratio images were printed on 100 sheets after 1%-print ratio images were printed on 1000 sheets by using the b toner above-described supply control was evaluated. As a result, it could be confirmed that there was a density fluctuation up to 1.75 at the maximum during continuous printing at the 30% print ratio from 1.45 as the center of the image density in the conventional triple control, but in the control of this embodiment, the density fluctuation can be suppressed to 1.50 at the maximum.

### (Measurement of Toner Charge Amount)

FIG. 7 is an illustration of a structure of the Faraday-Cage capable of measuring the toner charge amount. In this embodiment, a toner charge amount Q/M was measured using Faraday-Cage as shown in FIG. 7. The Faraday-Cage includes a double cylinder in which metal cylinders different in shaft diameter are coaxially provided, and further includes a toner collecting filter paper (filter) 93 for collecting the toner in an inner cylinder of the double cylinder. An inner cylinder 92 and an outer cylinder 91 are insulated by an insulating member 94, and when charged particles with a charge amount q are placed in the inner cylinder 92, it is similar to as if a metal cylinder with an electric amount q exists by electrostatic induction.

Further, the amount of the charges induced in the double cylinder was measured by KEITHLEY 616DIGITAL ELECTROMETER, and a value obtained by dividing the measured charge amount by a weight of the toner in the inner cylinder was the toner charge amount Q/M.

### Modified Embodiment

In the above-described embodiment, a preferred embodiment of the present invention was described, but the present invention is not limited thereto and is capable of being variously modified within the scope of the present invention.

### Modified Embodiment 1

In the above-described embodiment, the correction coefficient was α0.7(ΔV<10) and α0.1(ΔV≥10), but the present invention is not limited thereto. For example, a constitution in which the target TD ratio Vtrg is changed to a value small or than the target TD ratio Vtrg before switching without changing the correction coefficient at the time of switching from the low print ratio image to the high print ratio image may also be employed. Specifically, a constitution in which the target TD ratio Vtrg is constituted as 7% which was 3% decreased from 10% before the switching may also be employed. Further, even at the time other than when the correction coefficient is made small, during the switching from the low print ratio image to the high print ratio image, control such that a ratio of the toner content control supply amount F(Td), which is a factor of the image density fluctuation, to the video count amount control supply amount F(V) is made small may only be required to be carried out. During the switching from the low print ratio image to the high print ratio image, the toner content control supply amount F(Td) at the time of the low print ratio image is made smaller than the toner content control supply amount F(Td) at the time of the high print ratio image.

### Modified Embodiment 2

Further, in the above-described embodiment, in the case where a fluctuation in print ratio during the printing increases from a first value to a second value which is a predetermined value or to a value exceeding this (second) value, the ratio of the toner content control supply amount F(Td) to the video count amount control supply amount F(V) was made small. However, the present invention is not limited thereto, and in the case where the fluctuation in print ratio during the printing increases from the first value to the second value which is a variable value, the ratio of the toner content control supply amount F(Td) to the video count amount control supply amount F(V) may also be made small. At the time of switching from the low print ratio image to the high print ratio image, the toner content control supply amount F(Td) at the time of the high print ratio image is made smaller than the toner content control supply amount F(Td) at the time of the low print ratio image.

That is, this can be met by stepwisely decreasing the correction coefficient a in accordance with a degree of a stepwise increase in print ratio change rate ΔV as in the case of 6a&=0.3, at ΔV>5, α=0.1 at ΔV>10 and α=0 at ΔV>20, for example. In this case, there is a tendency that an unnecessary supply amount by the toner content control supply amount F (TD) increases with an increasing print ratio change rate ΔV, and therefore, by stepwisely making a small so as to cancel the increasing tendency, an effect of further stabilizing the toner charge amount is obtained.

### INDUSTRIAL APPLICABILITY

According to the present invention, there is provided an image forming apparatus capable of suppressing the image density fluctuation which can occur during switching from the low print ratio image to the high print ratio image without lowering productivity.

### EXPLANATION OF SYMBOLS

1 . . . photosensitive drum, 10 . . . toner content sensor, 11 . . . video count processing circuit, 15 . . . controller, 40 . . . developer container, 41 . . . developing sleeve, 46 . . . developer cartridge

1. An image forming apparatus comprising:
an image bearing member;
a developer carrying member for carrying a developer containing toner and a carrier and for developing an electrostatic image formed on said image bearing member;
a developer container for accommodating the developer to be supplied to said developer container;
a detecting portion for detecting a toner content in the developer in said developer container;
a supplying device for supplying the toner to said developer container; and
a controller for controlling an amount of the toner supplied from said supplying device to said developer container on the basis of a first toner supply amount acquired on the basis of an image ratio of an image formed on said image bearing member and a second toner supply amount acquired so that the toner content is a target value on the basis of an output of said detecting portion,
wherein in a case that an image ratio of a plurality of continuous images is higher than an image ratio of a predetermined number of continuous images and that a fluctuation of the image ratio of the plurality of continuous images to the image ratio of the predetermined number of continuous images is larger than a predetermined value, said controller controls the second toner supply amount so that the second toner supply amount is less than the second toner supply amount in a case that the fluctuation is smaller than the predetermined value.

2. An image forming apparatus according to claim 1, wherein in a case that a ratio of an image ratio of a second number of formation of continuous images smaller than a first number to an average of image ratios of the first number of formation of continuous images is larger than a predetermined value, said controller controls the second toner supply amount so that the second toner supply amount is less than the second toner supply amount in a case that the fluctuation is smaller than the predetermined value.

3. An image forming apparatus according to claim 1, wherein said controller determines the amount of the toner supplied from said supplying device to said developer container by adding the first toner supply amount acquired on the basis of an image ratio of an image formed on said image bearing member and the second toner supply amount acquired so that the toner content is a target value on the basis of an output of said detecting portion.

4. An image forming apparatus according to claim 1, wherein the second toner supply amount is acquired by multiplying a difference between the toner content detected by said detecting portion and the target value by a correction coefficient, and
wherein said controller decreases the correction coefficient in a case that the fluctuation is larger than the predetermined value.

5. An image forming apparatus according to claim 1, wherein said controller stops control of decreasing the second toner supply amount when a state is switched from a state in which a ratio of an image ratio of a second number of formation of continuous images smaller than a first number to an average of image ratios of the first number of formation of continuous images is larger than a predetermined value, to a state in which the ratio is smaller than the predetermined value.

6. An image forming apparatus according to claim 1, comprising video count means for counting a video count number of a density signal of an image information signal for each pixel of the image,
wherein said video count means calculates the image ratio.

7. An image forming apparatus according to claim 1, comprising an image density sensor for detecting a density of the image formed on said developer carrying member by development,
wherein a target value is set on the basis of an output of said image density sensor.

8. An image forming apparatus according to claim 1, wherein the second toner supply amount is acquired by multiplying a difference between the toner content detected by said detecting portion and the target value by a correction coefficient, and
wherein said controller decreases the target value in a case that the fluctuation is larger than the predetermined value.

9. An image forming apparatus comprising:
an image bearing member;
a developer carrying member for carrying a developer containing toner and a carrier and for developing an electrostatic image formed on said image bearing member;
a developer container for accommodating the developer to be supplied to said developer container;
a detecting portion for detecting a toner content in the developer in said developer container;
a supplying device for supplying the toner to said developer container; and
a controller for controlling an amount of the toner supplied from said supplying device to said developer container on the basis of a first toner supply amount acquired on the basis of an image ratio of an image formed on said image bearing member and a second toner supply amount acquired so that the toner content is a target value on the basis of an output of said detecting portion,
wherein said controller controls the amount of the toner so that an amount of the toner supplied after continuous image formation of images with a second image ratio of 30% or more is started after continuous image formation of a preset number of images with a first image ratio of 5% or less is less than an amount of the toner supplied after image formation of a preset number of images with the second image ratio of 30% or more.

10. An image forming apparatus according to claim 1, wherein the present number is 1000 or more.

11. An image forming apparatus according to claim 9, comprising video count means for counting a video count number of a density signal of an image information signal for each pixel of the image,
wherein said video count means calculates the image ratio.

12. An image forming apparatus according to claim 9, comprising an image density sensor for detecting a density of the image formed on said developer carrying member by development,
wherein a target value is set on the basis of an output of said image density sensor.
